(19) United States
(12) Patent Application Publication
(10) Pub. No.: US 2017/0223773 A1
(43) Pub. Date: Aug. 3, 2017

(54) DEVICE AND COLLECTIVE HEATING INDIVIDUAL

(71) Applicant: Juan Sebastian Izquierdo Vargas, Vina del Mar (CL)

(72) Inventor: Juan Sebastian Izquierdo Vargas, Vina del Mar (CL)

(21) Appl. No.: 15/501,291

(22) PCT Filed: Jul. 28, 2015
(86) PCT No.: PCT/CL2015/050026

§ 371 Date: Feb. 2, 2017

(30) Foreign Application Priority Data
Aug. 4, 2014 (CL) 2067-2014

(51) Int. Cl. H05B 1/02; A47K 10/48

(52) U.S. Cl. CPC H05B 1/0297; A47K 10/48

(57) ABSTRACT

Individual heater device (1) that generates a microclimate between the skin and the layer of clothing of a user such that the body is warmed and the clothing dried, which comprises an interior chamber (A), a generator unit (B) that produces warm air that comprises a motor (C) that actuates a turbine (D) that generates air, the flow of air from this turbine being directed towards an electrical resistance element (E), and it further comprises a casing (120) that contains said generator unit (B), an internal chamber (G) for distribution of the warm air coming from the generator unit (B) and it comprises a plurality of outlet ducts (130) for the warm air towards the exterior. Collective heater device (100) that comprises a gas-powered industrial heater (F), a motor (C) that actuates a turbine (D) that generates air, the flow of air from the turbine being directed towards a heat exchanger (E), wherein the collective heater device further comprises a casing (10′) that contains an internal chamber (20′) for distribution of the warm air coming from an industrial heater (F) and it comprises at least two assemblies (300) that comprise outlet ducts (30′) for the warm air towards the exterior.

The present invention relates to a heating device that generates a microclimate between the skin and the layer of clothing of a user, his whole body heating, dehumidifying their clothes and shoes.

### BACKGROUND OF THE DISCLOSURE

Maintain body temperature in cold climates or environments is always a problem of great importance and that directly affects the quality of life, health and productivity of people.

The traditional way to address this problem has been to be heated environments in which people live, work, study, etc. To the above there are a variety of systems, such as central heating, heat pumps, electric stoves, gas stoves, fireplaces, wood stoves, etc. The problem with this traditional approach is the high cost associated with room heating, air volumes in rooms, or normally houses, buildings or entire buildings. The above problem is accentuated in the case that the buildings having poor insulation or in the case of a cold and/or humid environment.

Besides the traditional approach it is not useful for the case of people who develop some activity outdoors, for example in forestry and mining sites, sports centers, and/or roofed areas as closed sheds and carports open impossible of heating, etc.

In Chile, according to information available on the market, a high percentage of households have little or no insulation. A second group, corresponding to a lower percentage of households has insulation in walls and ceilings of this group of households, an even smaller percentage have double glazing or thermo panels. This reality allows us to conclude that room heating is extremely onerous considering that much of this heat energy is lost through walls, ceilings, roofs, windows and doors. This explains why it exists in our society, a huge need for efficient and economical heating.

As it is practically impossible to improve the insulation of homes to optimize the use of heat energy in such a way of heating environments and then be heated people, has developed, in concordance to this need, a heating system that specializes in be heated and dehumidified directly to the person, enabling the latter to enjoy a better quality of life.

The subject invention overcomes the problems widely and successfully raised above injecting a blast of hot pressure between the body and clothing of the user air, replaced in seconds the mass of air between the body and clothing of the user. This mass of hot air pressure and humidity slurried clothing forcing her to go outside through their tissues. Following the above process, a microclimate between the body and clothing of the user depending on atmospheric conditions can be maintained for hours is formed.

The proposed invention calef drives and dehumidify people, not environments, making their energy use is far more efficient than all other conventional heating systems existing in the world market.

The heater of the present invention, the device is responsible for the problems caused by the cold and damp of people (lack or no heating), therefore, has direct application in all households (families) and all types of organizations such as public and private offices, companies removed tasks or icy as mining, construction of roads, fishing, workshops, armed forces, as well as colleges, universities and in general areas, all kinds of activity undertaken in environmental conditions described above, ie with dank room temperature.

When it is dehumidified and calefaccionando, the body needs less energy to maintain its temperature, therefore this system to achieve the goal in just seconds, can keep the immune system in good condition, avoiding a high percentage of diseases caused by cold and humidity, typical of the winter months conditions.

In the prior art and the patent document certain heating devices are known, for example, U.S. Pat. No. 912,527 teaches a system that allows heat the body of a person through a series of conduits through which circulates a hot fluid, with the heated fluid in a combustion chamber, the hot fluid is drawn into body parts to maintain its temperature. The system needs to be led and run constantly to achieve the heating of the individual.

U.S. Pat. No. 3,110,301 describes a system comprising a combustion chamber which is carried by the body and flowing the combustion products into a chamber below the clothing of the person. This system needs to be led and run constantly to achieve the heating of the individual.

U.S. Pat. No. 5,930,912 shows document dryer collapsible system, which directs multiple jets of air into the body of a person in order to dry it. This system is focused on people dry after a bath or leaving a pool, that is not allowed to dry fully dressed person. As can be seen, in the prior art there are different types of heating devices, but none of them includes a plurality of outlet ducts hot air that are adjustable to introduce the hot air to various areas of the human body.

### SUMMARY OF THE INVENTION

The present invention describes an individual heating device generating a microclimate between the skin and clothes of a user, so that the heated and dehumidified clothes basically comprises an inner chamber (A) which has a generating unit (B) producing hot air comprising a motor (C) driving a turbine (D) generating air, the air flow of this turbine directed towards a resistor (E) being electric; further comprising a housing containing said generating unit (B) contains an internal distribution chamber of hot air from the generator unit (B) and has a plurality of outlet ducts hot air to the outside.

The invention comprises a method of application that perform the same function but a set of people, at least two, being this type composed of the same elements as individual, but in this case, the generator means hot air can be an Industrial gas heater, then being added evacuator flue outwardly and having along a housing of larger dimensions, several sets of outlet ducts of hot air, next to each other in a line distribution, for various users simultaneously, but may also be another distribution depending on the configuration of the housing.

Another embodiment may be the same as just described, but instead of generating heat with an industrial gas heater, may be also with an electrical resistance, but since the application is to cover the need for at least two persons, size resistance and flow engine generator must be calculated according to the need and availability of energy.

For applications for more than 10 or 14 employees it is necessary to use gas. Facilities for industries with 30 to 40 Amperes system could include 3 outputs. For workers a system that provides gas for energy saving is required. The amount of gas should be regulated by computer for proper air pressure heat addition. The combination of forced air slurried moisture and body moves outward leaving the body dry.

### BRIEF DESCRIPTION OF THE FIGURES

A detailed description of the invention, will be held in conjunction with the figures that are part of this presentation, wherein:

FIG. 1 shows a diagram (side view in longitudinal section) showing the components of individual heating device.

FIG. 1b shows a side view in longitudinal section of an embodiment of the individual heating device of the present invention showing the components thereof.

FIG. 2 shows a rear perspective view of one of the preferred embodiments of the individual heating device.

FIG. 3a shows a top view of the mode of individual heating device taught in FIG. 2 plant.

FIG. 3b shows a top view of one preferred embodiment the heating device individual plant.

FIG. 4 shows a rear elevation of the preferred embodiment of the individual heating device taught in FIG. 2.

FIG. 5a shows a side elevation view showing the components of the collective heating device of the present invention.

FIG. 5b shows a top plan view of the collective heating device of the present invention.

FIG. 5c shows a perspective view of the collective heating device of the present invention.

FIG. 5d shows a rear elevation of the collective heating device of the present invention.

FIG. 6 shows a side view in longitudinal section of the collective heating device of the present invention.

FIG. 7 shows a perspective view of the collective heating device of the present invention showing a set of individual device replicated.

### DESCRIPTION OF THE INVENTION

The present invention comprises an individual heating device (1) generating a microclimate between the skin and the layer of clothing of a user, so that it heats and dehumidifies clothing, comprising an inner chamber (A), a unit generating (B) it is producing hot air comprising a motor (C) driving a turbine (D) generating air, the air flow of this turbine directed towards a resistor (E) electrical being, and further comprising a housing (120) It is containing said generating unit (B), an internal distribution chamber (G) of the hot air from the generator unit (B) and comprises a plurality of output ports (130) hot air to the outside. The housing (120) of the individual heating device (1) consists of a hollow body having an inner face (102), an outer face (101) and having an inlet (103) of air coming from the outside environment. The internal distribution chamber (G) is formed between the inner face (102) of the housing (120) and said inner chamber (A) of the device (1), wherein said distribution chamber (G) has an output (201) hot air from said inner chamber (A) and at least one outlet (202) of said hot air.

The individual heating device (1) comprises at least one outlet (202) of hot air distribution chamber (G) which is in communication with said outlet ducts (130) of hot air from the housing (120), said outlet ducts (130) of hot air from the housing (120) having a proximal end (301) and a distal end (302), and at least one duct lower outlet (131) pulling hot air in the area the user's feet.

Outlet ducts (130) of hot air from the housing (120) of the individual heating device (1) comprising at least one outlet conduit leg (132) which pulls hot air, whose distal end is disposed between the skin and the user clothing. Outlet ducts (130) of hot air from the housing (120) of the individual heating device (1) comprising at least one duct accessory outlet (133) pulling hot air, at the distal end (302) can be placed footwear such as shoes, sneakers or boots, and/or socks.

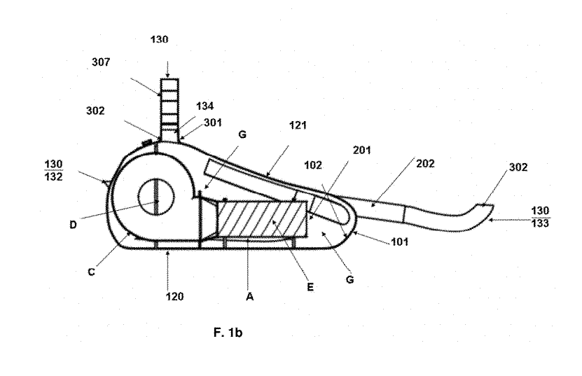

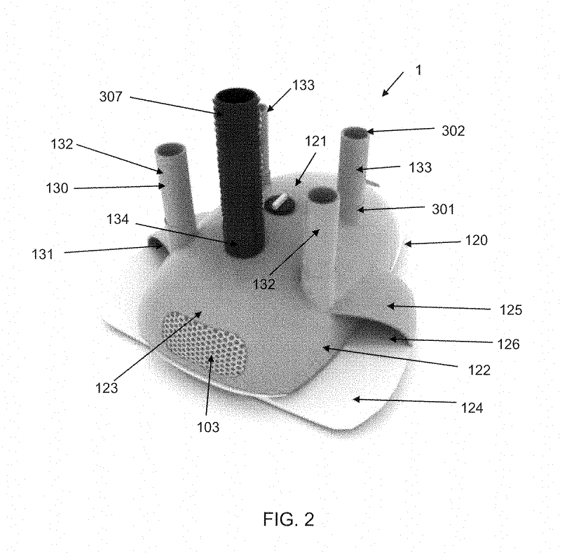

Outlet ducts (130) of hot air from the housing (120) of the individual heating device (1) (shown in FIG. 2) comprising at least one extender conduit (134) output pulling hot air, located in the central area of the upper surface (121) of the housing (120), at the distal end (302) a flexible conduit (307) of greater length is connected to the rest of the ducts (130) of hot air outlet to reach the user's torso or upper body including the user's hair. The housing (120) of the individual heating device (1) has a rear upper surface (121), lateral sides (122) and side (123) where an air inlet (103) is provided from the outside, from which projected an outgoing side pieces (124) for the user to pose their feet, which in turn has a top cover (125) covering said sidepieces protrusions, generating a cavity (126).

Outlet ducts (130) of hot air from the housing (120) comprising at least one duct bottom outlet (131) pulling hot air into the footwell of the user located inside the cavity (126) of the housing (120).

Outlet ducts (130) of hot air from the housing (120) comprising at least one outlet conduit leg (132) located in the rear area of the upper surface (121) of the housing (120), wherein the end distal of said outlet conduit leg (132) pulls hot air between the skin of the wearer's legs and trousers, and wherein the distal end is tilted 45 degrees from the horizontal plane.

Outlet ducts (130) of hot air from the housing (120) comprising at least one duct accessory outlet (133) located in the front area of the upper surface (121) of the housing (120), wherein the distal end (302) accessory outlet duct (133) comprises a flexible hose or telescopic lets get to the bottom of the boots or booties to achieve the goal of dry shoes.

The collective heater (100) of the present invention device generates a microclimate between the skin and the layer of clothing several users at once, in order of heating and dehumidifying his clothes, and comprises an inner chamber, a generating unit that produces hot air comprising an industrial gas heater (F), a motor (C) driving a turbine (D) generating air, the air flow of this turbine directed towards a heat exchanger (E) being where the heating device group further comprises a housing (10′) containing said generating unit contains an internal distribution chamber (20′) of hot air from the industrial gas heater (F) and comprises at least two sets (300) comprising outlet ducts (30′) hot air to the outside.

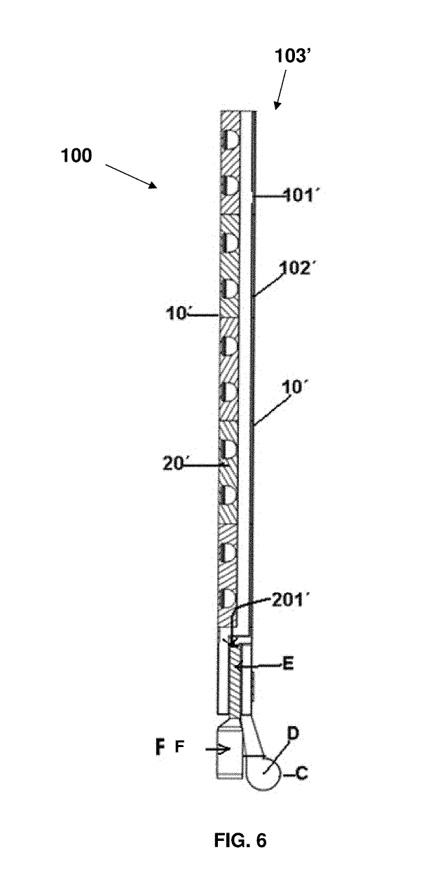

The housing (10′) of the collective heating (100) device is formed by a hollow body having an outer face (101′), an internal face (102′) (shown in FIG. 6) and has an evacuator flue (103′) of combustion to the outside that is located between the outer face (101′) and the inner face (102′). The internal distribution chamber (20′) of the collective heating device (100) is formed between the outer face (101′) of the housing (10′) and has an outlet (201′) of the hot air from the heater Industrial gas (F), and with at least one outlet duct (30′) of said hot air. The at least outlet pipe (30′) of hot air distribution chamber (20′) is in communication with said sets of ducts hot air outlet of the housing (10′).

Sets (300) of output ports (30′) are arranged adjacent to one another along the casing (10′) comprising a module for an individual person replicated heating device. Sets (300) of output ports (30′) of hot air from the housing (10′) comprise at least one duct bottom outlet (303′) pulling hot air in the area of the user's feet, which bifurcates shoes or at least two outlet ducts (30′). Sets (300) of output ports (30′) of hot air from the housing (10′) comprise at least one outlet conduit leg (304′) pulling hot air, whose distal end is disposed between the garment and the user's torso, where the outlet conduit leg (304′) may be a conduit bifurcates into two or more. Sets (300) of output ports (30′) of hot air from the housing (10′) comprise at least one duct accessory outlet (305′) pulling hot air, at the distal end can be placed footwear, such like shoes, slippers, boots or socks. Sets (300) of output ports (30′) of hot air from the housing (10′) comprise at least one expander outlet conduit pulling hot air, at whose distal end a flexible conduit (307′) connects greater length than the rest of the ducts (30′) of hot air outlet, to achieve the user's torso or upper body.

### DETAILED DESCRIPTION OF THE INVENTION

The heating device of the present invention basically consists of a housing inside has a motor driving a turbine generator air, while the air flow of this turbine directed towards an electrical resistance.

At the exit of the electrical resistance are tubes that carry hot air to various air outlets. Each air outlet injected hot air and has a specific function, one of the outputs has a shape specially adapted to place in this footwear (shoes, shoe, boots, etc.), another outlet is adapted to dry the torso of a person, other outlet is adapted to dry pants one person and another output has a specific way to allow to dry the feet of a person.

In addition, the system has a controller which allows the user to set the temperature and time of use of the system. The controller lets you choose from time default use (e.g. 30 or 60 seconds), the default time use is in the range from 10 to 180 seconds, preferably from 15 to 120 seconds and more preferably from 30 to 60 seconds. In normal use during a session, the user leaves his shoes on the output for shoes and put your feet on exits to dry feet, so that while the outputs to dry pants fall below the pants, injecting air between the pants and legs of the person.

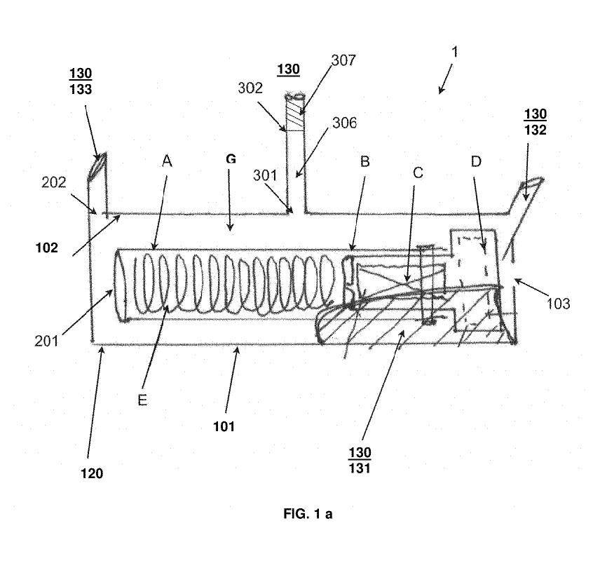

According to the contents of FIGs. 1a and 1b, the present invention is an individual heating device (1) generating a microclimate between the skin and the layer of clothing of a user, so that the heated and dehumidified clothes, comprising basically an interior chamber (a) which has a generating unit (B) which produces hot air comprising a motor (C) driving a turbine (D) generating air, the air flow of this turbine directed towards being resistance (E) electricity.

The individual heating device comprises a housing (120) containing said generating unit (B) further contains an internal distribution chamber (G) of the hot air from the generator unit (B) and has a plurality of outlet ducts (130) hot air to the outside. Said housing (120) consists of a hollow body having an inner face (102), an outer face (101) and having an inlet (103) of air coming from the outside environment.

The internal distribution chamber (G) of the individual heating device is formed between the inner face (102) of the housing (120) and said inner chamber (A) of the device (1), wherein said distribution chamber (G) has an output (201) hot air from said inner chamber (A) and at least one outlet (202) of said hot air.

As it can be seen in FIGS. 1a and 1b, said at least one outlet (202) of hot air distribution chamber (G) is in communication with said outlet ducts (130) of hot air from the housing (120) and said outlet ducts (130) of hot air from the housing (120) having a proximal end (301) and a distal end (302). The aforementioned outlet ducts (130) hot air from the housing (120) comprising at least one bottom outlet conduit (131) that pulls hot air in the area of the user's feet and can be used for the user's feet with or without socks. Lower outlet ducts (131) may be at least two, in the case of a user. Lower outlet ducts (131) can be multiple conduits in case more than one user for industrial heating. Lower outlet ducts (131) may be a conduit bifurcates into two or more ducts.

Outlet ducts (130) of hot air from the housing (120) also they comprise at least one outlet conduit leg (132) which pulls hot air, whose distal end is disposed between the skin of the wearer's legs and trousers. The outlet conduit leg (132) comprises a conduit bifurcates into two or more conduits or may be two outlet ducts for leg (132) one for each foot or leg of the user.

Outlet ducts (130) of hot air from the housing (120) comprising at least one outlet pipe fitting (133) pulling hot air, at the distal end can be placed shoes, socks, etc. The accessory outlet duct (133) for socks or shoes may comprise a flexible hose to dry boots. Outlet ducts (130) comprising at least one extender conduit (134) output pulling hot air, at the distal end (302) a flexible conduit (307) of greater length is connected to the rest of the conduits (130) output of hot air.

According to the content of FIG. 2, the individual heater (1), the device comprising a housing (120) having a rear upper surface (121), side edges (122) and side (123) where an air inlet is provided (103) from the outside.

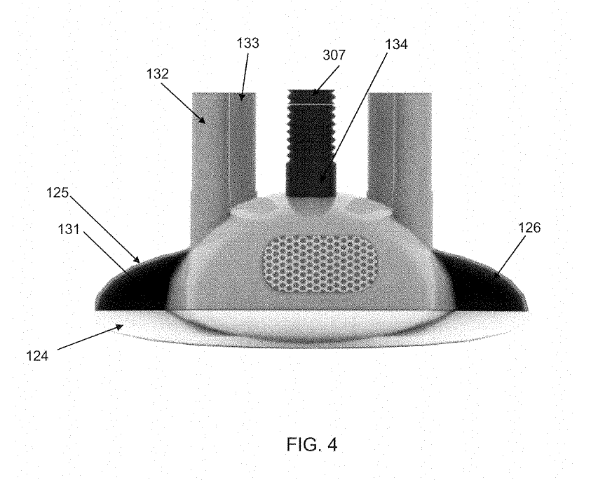

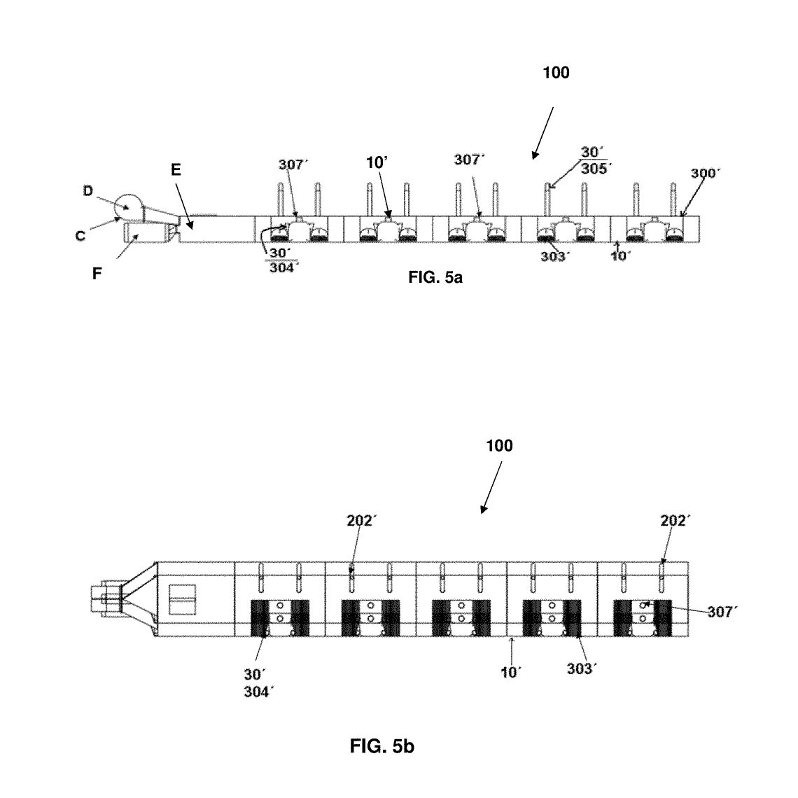

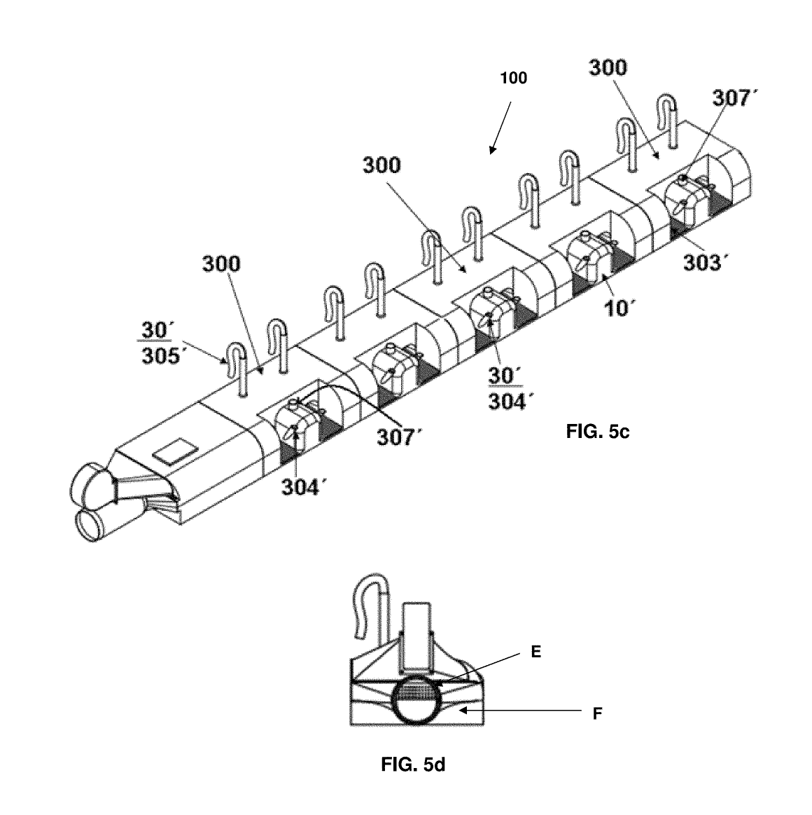

As best seen in FIGS. 2, 3a, 3b and 4, since the lateral sides (122) of the housing (120) side pieces projecting protrusions (124) for the user to pose their feet, which in turn has a top cover (125) covering partially said projecting side pieces (124), generating a cavity (126).

From what can be seen in FIGS. 2, 3a, 3b and 4, the outlet ducts (130) of hot air from the housing (120) having a proximal end (301) and a distal end (302) and comprising at least one duct bottom outlet (131) pulling hot air into the footwell of the user located inside the cavity (126) of the housing (120).

As best seen in FIG. 2, said outlet ducts (130) of hot air from the housing (120) comprising at least one outlet conduit leg (132) located in the rear area of the upper surface (121) the housing (120), wherein the distal end of the outlet conduit leg (132) pulls hot air between the skin of the wearer's legs and trousers.

In one embodiment of the heating device of the present invention the outlet leg (132) is inclined laterally and has a low height so that it fits the user's pants. The outlet conduit leg (132) may be inclined 45 degrees from the other ducts or to the plane of support of the device. The outlet conduit leg (132) is diagonally or 45 degrees from the horizontal plane and at low height so that it is tucked in when the user rests his feet in the use position on outgoing side pieces (124).

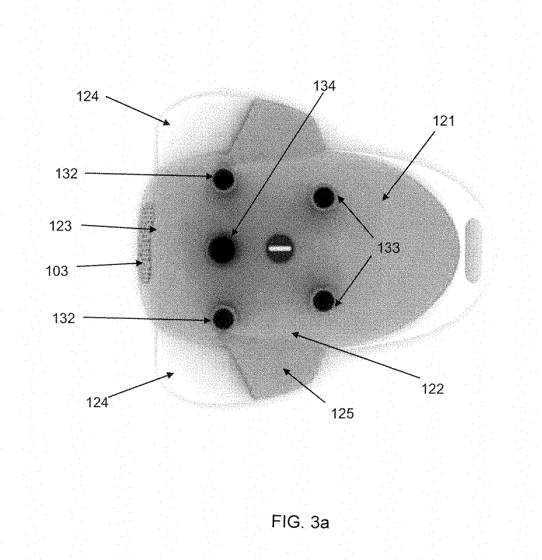

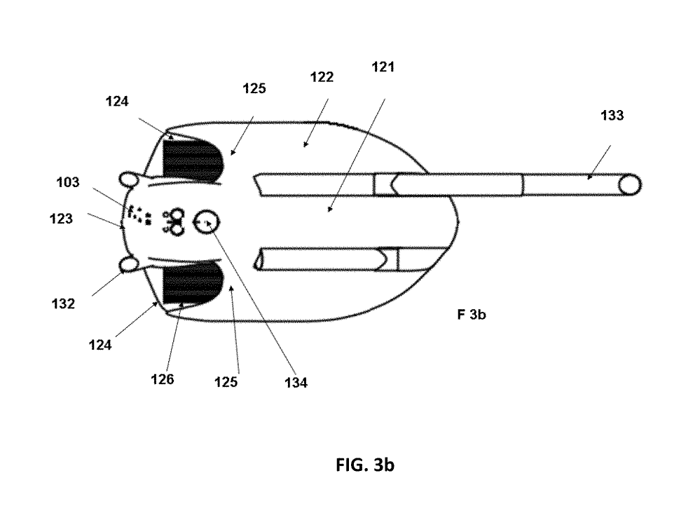

Said outlet ducts (130) of hot air from the housing (120) comprising at least one duct accessory outlet (133) located in the front area of the upper surface (121) of the housing (120), where its distal end (302) can be telescopic and flexible and allows you to place shoes and/or socks. As shown in FIGS. 2, 3a and 3b, the outlet ducts (130) of hot air from the housing (120) comprising at least one extender conduit (134) output pulling hot air located in the central area the top surface (121) of the housing (120), at the distal end (302) a flexible conduit (307) longer than the rest of the ducts (130) of hot air outlet connects. This flexible conduit (307), being of greater length can have an extension of at least one meter long or a long equal to the average height of a person, wherein said flexible conduit (307) can be manipulated by the user for e.g. apply in the torso of the body, including the skin and clothing and allowed to dry for example the back, chest, or hair.

5a, 5b, 5c and 5d show an embodiment of the invention comprising a collective heating device (100) generating a microclimate between the skin and the layer of clothing several users at once, so heated and dehumidified their clothes. The heating device (100) comprises basically comprises an internal distribution chamber (20′), a generating unit that produces hot air comprising an industrial gas heater (F), a motor (C) driving a turbine (D) air generator, air flow of this turbine directed towards a heat exchanger (E) being.

Where the collective heating (100) of the present invention comprises a housing (10′) comprising an internal distribution chamber (20′) of hot air from the generating unit and comprises at least two sets (300) of ducts outlet (30′) hot air to the outside.

The housing (10′) is formed by a hollow body having an outer face (101′), an internal face (102′) and has an evacuator gas conduit (103′) to the outside. 6 shows the internal distribution chamber (20′) formed between the outer face (10) of the housing (10′) and an inner chamber of the device, wherein said distribution chamber (20′) has an inlet (201′) hot air from said inner chamber and at least one outlet (202′) hot air.

The at least one outlet of hot air distribution chamber (20′) is in communication with said set (300) comprising outlet ducts (30′) of hot air from the housing (10′) and where these latter have a proximal end and a distal end, while sets (300) of output ports (30′) are arranged adjacent one another, along the housing (10′) comprising a single heating device replicated.

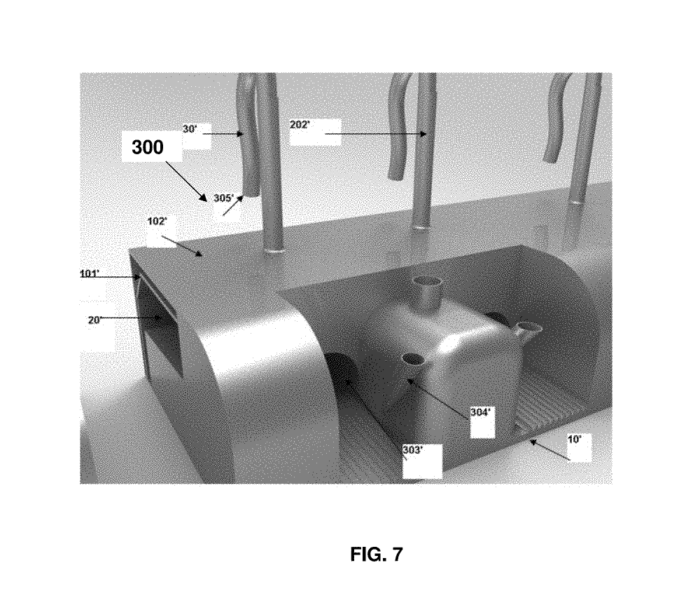

A set (300), for example as shown in FIG. 7, comprises outlet channels (30′) of hot air from the housing (10′) comprise at least one duct bottom outlet (303′) pulling hot air in the area of the user's feet; also they comprise at least one outlet conduit leg (304′) pulling hot air, whose distal end is disposed between the skin of the wearer's legs and trousers. Further include at least one duct accessory outlet (305′) pulling hot air, at the distal end can be placed footwear, socks, etc., and finally, also comprising at least one extender conduit (not shown in the figure) pulling out warm air, at the distal end a flexible conduit (307′) of greater length than the rest of the ducts (30′) of hot air outlet is connected.

In the individual heating device or heating device in the group of the present invention the temperature is adjustable. Moreover, individual heating device or collective heating device require the volume coming out of it is sufficient to ensure displace air lodged between clothes and body and achieve wick moisture away from the body and in order to heat the body and clothing and keep the body and clothing dry.

The volume of air exiting the individual heating device is in the range of 2000 to 4000 liters per minute per person. Preferably the volume of air leaving the device is in the range 3000 liters or more per minute per person. More preferably 3400 liters per minute per person. If greater volume of air is used, the power consumption is higher but the fastest effect is achieved, this is achieved by moving the air lodged between clothes and body and wick moisture away from the body faster.

The collective heating device requires a larger air volume, about 6000 liters per minute. The amount of air column depends on the number of users of the collective heating device. For example, more than 10,000 liters per minute is required for four users and more than 20,000 liters per minute are required for 8 or more users. The collective heating device requires the use of turbines for operation, however turbines are inexpensive so increase the number of users has no greater impact on the value of collective heating device of the present invention.

In the individual heating device of the present invention or the collective heating device, the air flow can be cut into any output, specifically for drying a single body part independently, depending on the user equipment. Also in the collective heating device of the present invention the air flow can be cut into any output specifically for drying a single body part independently.

The outlet conduit leg (132), shown in 1b and 3b, is diagonally or 45 degrees from the already low horizontal plane height to be within the pants when the user rests his feet in the use position on the outgoing side pieces (124).

The present invention relates to an individual heating device (1) generating a microclimate between the skin and the layer of clothing of a user, so that it heats and dehumidifies clothing, comprising an inner chamber, a generating unit that produces hot air comprising a motor© driving a turbine (D) generating air, the air flow of this turbine directed towards a resistor [symbol] electrical being, and further comprising a housing (120) containing said unit generating (B), an internal distribution chamber (G) of the hot air from the generator unit (B) and comprises a plurality of output ports (13=hot air to the outside.

The individual heating device (1), of the present invention comprises a housing (120) it consists of a hollow body having an inner face (102), an outer face (101) and having an inlet (103) of air coming from the outside environment. The internal distribution chamber (G) is formed between the inner face (102) of the housing (120) and said inner chamber (A) of the device (1), wherein said distribution chamber (G) has an output (201) hot air from said inner chamber (A) and at least one outlet (202) of said hot air.

1. Individual heating device (1) generating a microclimate between the skin and the layer of clothes of a user, so that dehumidifies and heats clothes, comprising an inner chamber (A), a generating unit (B) producing hot air comprising a motor (C) driving a turbine (D) generating air, the air flow of this turbine directed towards a resistor (E) electrical being, and further comprising a housing (120) containing said generator unit (B), an internal distribution chamber (G) of the hot air from the generator unit (B) and comprises a plurality of output ports (130) hot air to the outside. wherein said outlet ducts (130) of hot air from the housing (120) having a proximal end (301) and a distal end (302).

2. Device single heater (1) according to claim 1, wherein said outlet ducts (130) of hot air from the housing (120) comprising at least one duct bottom outlet (131) pulling hot air in the area of the user's feet.

3. Device single heater (1) according to claim 1, wherein said outlet ducts (130) hot air comprise at least one outlet conduit leg (132) which pulls hot air, whose distal end (302) is It disposed between the skin and clothing of the user.

4. Device single heater (1) according to claim 1, wherein said outlet ducts (130) hot air comprise at least one duct accessory outlet (133) pulling hot air, at the distal end (302) is they can be placed footwear, such as shoes, sneakers or boots, and/or socks.

5. Device single heater (1) according to claim 1, wherein said outlet ducts (130) of hot air from the housing (120) comprising at least one extender conduit (134) output pulling hot air located in the central area of the upper surface (121) of the housing (120), at the distal end (302) a flexible conduit (307) of greater length is connected to the rest of the ducts (130) of hot air outlet for reaching the wearer's torso or upper body including the user's hair.

6. Individual heating device (1) according to claim 1, wherein said housing (120) has a rear upper surface (121), side edges (122) and side (123) where an air inlet is provided (103) from the outside, from which side pieces projections (124) projecting for the user to pose their feet, which in turn has a top cover (125) covering said sidepieces protrusions, generating a cavity (126).

7. Individual heating device (1) according to claim 6, wherein said outlet ducts (130) of hot air from the housing (120) comprising at least one bottom outlet conduit (131) pulling hot air the area of the user's feet located inside the cavity (126) of the housing (120).

8. Individual heating device (1) according to claim 6, wherein said outlet ducts (130) of hot air from the housing (120) comprising at least one outlet conduit leg (132) located in the rear area of the upper surface (121) of the housing (120), wherein the distal end of said outlet conduit leg (132) pulls hot air between the skin of the wearer's legs and trousers and wherein the distal end is inclined 45 degrees from the horizontal.

9. Individual heating device (1) according to claim 6, wherein said outlet ducts (130) of hot air from the housing (120) comprising at least one outlet duct accessory (133) located in the front area of the upper surface (121) of the housing (120), wherein the distal end (302) of the duct accessory outlet (133) comprises a flexible hose or telescopic that allows reaching the bottom of the boots or booties to achieve the goal of dry shoes.

10. Device collective heater (100) generating a microclimate between the skin and clothing layer several users at once, to be heated and dehumidified their of clothes, which comprises an inner chamber, a generating unit that produces air hot comprising an industrial gas heater (F), a motor (C) driving a turbine (D) generating air flow turbine air directed to a heat exchanger (E) being where the collective heating device further comprising a housing (10′) containing an internal distribution chamber (20′) of the hot air from an industrial furnace (F) and comprises at least two sets (300) comprising outlet ducts (30′) of air hot outwards.

11. Device collective heater according to claim 10, wherein said housing (10′) comprises a hollow body having an outer face (101 body′), an internal face (102′) and has an evacuator gas conduit (103′) of combustion to the outside that is located between the outer face (101′) and the inner face (102′) of the collective heater.

12. Device collective heater according to claim 10, wherein said internal chamber (20′) is formed between the outer face (101′) of the housing (10′) and has an outlet duct (30′) of the hot air from the industrial furnace (F) and with at least one outlet (202′) of said hot air.

13. Device collective heater according to claim 10, wherein said at least one outlet duct (30′) of hot air distribution chamber (20′) is in communication with said sets of outlet conduits air hot housing (10′).

14. Device collective heater according to claim 10, wherein said joint (300) of output ports (30′) are arranged adjacent to one another along the casing (10′) comprising a module for person comprising an individual heating device replicated.

15. Device collective heater according to claim 10, wherein said joint (300) of output ports (30′) of hot air from the housing (10′) comprise at least one bottom outlet conduit (303′) pulling hot air in the area of the user's feet, which bifurcates for shoes or at least two outlet ducts (30′).

16. Device collective heater according to claim 10, wherein said joint (300) of output ports (30′) of hot air from the housing (10′) comprise at least one outlet conduit leg (304′) pulling hot air, whose distal end is disposed between the garment and the wearer's torso, where the outlet conduit leg (304′) may be a conduit bifurcates into two or more.

17. Device collective heater according to claim 10, wherein said joint (300) of output ports (30′) of hot air from the housing (10′) comprise at least one outlet pipe fitting (305′) pulling hot air at the distal end can be placed footwear, such as shoes, sneakers, boots or socks.

18. Device collective heater according to claim 10, wherein said joint (300) of output ports (30′) of hot air from the housing (10′) comprise at least one outlet conduit extensor pulling hot air at whose distal end a flexible conduit (307′) of greater length than the rest of the ducts (30′) of hot air outlet, to achieve the user's torso or upper body is connected.
